(19) United States
(12) Patent Application Publication
(10) Pub. No.: US 2023/0294666 A1
(43) Pub. Date: Sep. 21, 2023

(54) Method to Reduce Vehicle Rollover Probability by Laterally Shifting a Vehicle's Center of Mass

(71) Applicants: Vivian Hui, Charlottesvile, VA (US); Kai Hui, Charlottesville, VA (US)

(72) Inventors: Vivian Hui, Charlottesvile, VA (US); Kai Hui, Charlottesville, VA (US)

(21) Appl. No.: 18/153,980

(22) Filed: Jan. 12, 2023

Related U.S. Application Data
(60) Provisional application No. 63/269,543, filed on Mar. 17, 2022.

(51) Int. Cl. B60W 30/04; B60W 40/13; B60W 10/26

(52) U.S. Cl. CPC B60W 30/04; B60W 40/13; B60W 10/26; B60W 2710/24

(57) ABSTRACT

A novel method of preventing vehicle rollover by shifting center of mass (COM). Shifting 23% of a vehicle's total vehicle weight can increase the rollover impact energy threshold by 4 times on a scaled prototype SUV built in the research. This design can be implemented on commercial vehicles and greatly reduce the probability of vehicle rollover. Moreover, existing parts on the vehicle such as the battery on an electric vehicle can be used as the mobile weight to shift COM.

### BACKGROUND OF THE INVENTION

Preventing vehicle rollover can save many people's lives and is a serious topic. Several methods have been reported and patented. However, those methods are primarily on 1. Sensors to detect rollover beforehand 2. Some external forces, such as extra torque, generated by a vehicle to stabilize the vehicle. Those methods are usually complicated and cumbersome. Shifting COM is a much more simple and more practical method to stabilize a vehicle.

### SUMMARY OF THE INVENTION

Shifting the center of mass (COM) in order to stabilize and prevent loss of balance is an unconscious behavior for humans and other organisms. This vehicle rollover prevention method utilizes this simple yet unprecedented mechanism to reduce vehicle rollover probability.

This invention is to shift COM laterally to stabilize a vehicle. It is effective and practical.

Moreover, Electrical Vehicles (EVs) are gaining popularity. This invention proposes to use the EV battery as the mobile weight to shift COM. There is no added “dead weight”.

### BRIEF DESCRIPTION OF THE DRAWINGS

The features of embodiments of this invention will be more readily understood by reference to the following detailed description, taken with reference to the accompanying drawings, in which:

FIG. 1 provides a schematic illustration of COM shifting control system described in this invention

FIG. 2 shows % COM shift as a result of % distance of mobile weight movement. % COM shift is defined as COM shift/total vehicle width*100. % distance of weight movement is defined as mobile weight displacement/total vehicle width*100. Both calculated and measured % COM Shift are presented.

FIG. 3 shows the increase in the vehicle's rollover impact energy threshold as a result of % COM shift.

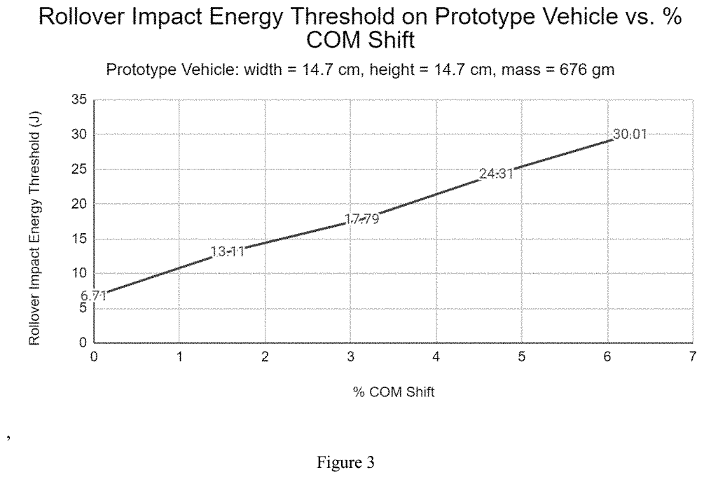

The rollover impact energy threshold was defined as the impact energy level at which the vehicle is rolled over. Testing was conducted on a scaled prototype SUV with a width of 14.7 cm, height of 14.7 cm, and mass of 676 grams. As seen in the figure, a 6.27% COM shift to the opposite direction results in 30.01 Joules of rollover impact energy threshold, more than 4 times larger than 6.71 Joules, the threshold when the COM is at the center of the SUV.

FIG. 4 shows the increased rollover impact energy threshold as a result of % distance of mobile weight movement. The mobile weight is 23% of the vehicle's total weight. 23% is the approximate ratio of an EV battery weight over an EV weight.

### DETAILED DESCRIPTION OF THE INVENTION

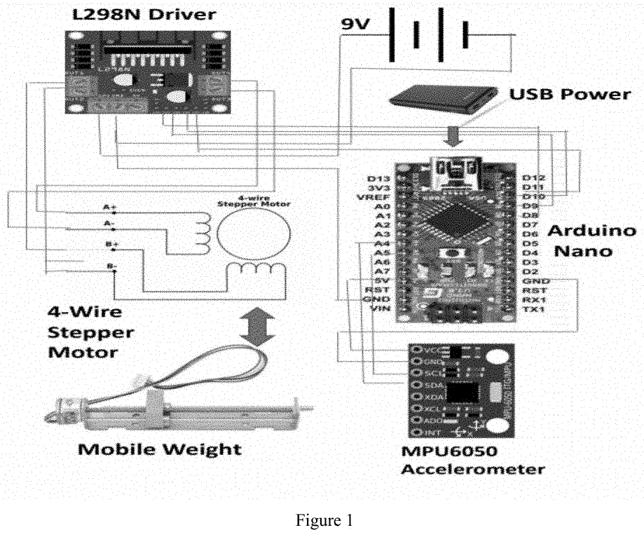

A scaled prototype vehicle is built. The vehicle is loaded with 155.5 grams of mobile weight, which is 23% of total vehicle weight. The vehicle is equipped with an Arduino microcontroller system to shift a mobile weight, such that the movement of the weight shifts the vehicle's COM. This mechanism is programmed to integrate an algorithm to process raw values read from an accelerometer into values to represent the tilt of the vehicle. A PID loop is then implemented to logically command a stepper motor to move the mobile weight. FIG. 1 shows the schematic illustration of the control system. A testing platform with slopes to simulate vehicle rollovers was constructed. Testing was performed to measure how different COM locations affect a vehicle's rollover impact energy threshold.

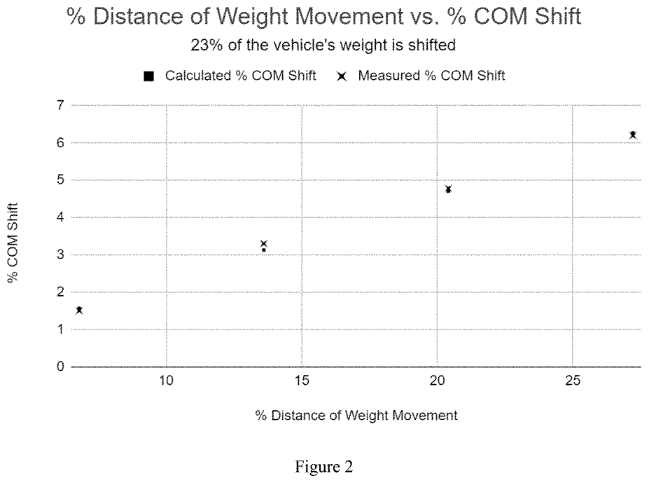

Shifting a mobile weight can shift a vehicle's COM. Balance tests were conducted to verify calculated COM shifting. FIG. 2 shows calculated COM shifting agrees well with the balance test measurement.

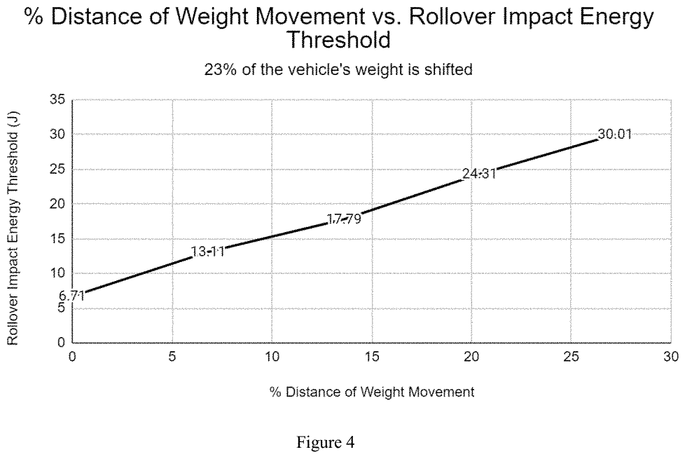

This research shows shifting a mobile weight laterally can effectively greatly reduce the probability of vehicle rollover. In some embodiments, the probability of vehicle rollover is reduced at least 5%, at least 5%, at least 10%, at least 15%, at least 20%, at least 25%, at least 30%, at least 40%, at least 50%, at least 60%, at least 70%, or at least 80%. Shifting 23% of a vehicle's total weight to less than 30% of the full vehicle width can effectively increase the vehicle's rollover impact energy threshold by 4 times, as shown in FIG. 4. Electrical vehicles (EVs) are gaining popularity. A typical EV battery weighs about 450 Kg, about 23% of total vehicle weight. Using an EV battery as a weight-shifting element is effective and would not add additional weight to the vehicle.

What is claimed is:

1. A method for reducing the probability of a vehicle rollover by shifting the center of mass (COM) laterally by means of shifting a part of the vehicle or an added weight.

2. The method of claim 1, wherein said vehicle is an electric vehicle.

3. The method of claim 2, wherein said part of the vehicle which is caused to shift laterally is the EV battery of the vehicle.

4. Using EV battery as the mobile weight to shift a vehicle COM to reduce vehicle rollover probability.
